(19) United States
(12) Patent Application Publication
(10) Pub. No.: US 2004/0113298 A1
(43) Pub. Date: Jun. 17, 2004

(54) Method for fabricating a preform for plastic optical fiber

(75) Inventors: Jin Taek Hwang, Daejeon-Shi (KR); Han Sol Cho, Daejeon-Shi (KR); Jin Sung Choi, Daejeon-Shi (KR); Yong Young Park, Daejeon-Shi (KR); Seung Hui Lee, Gumi-Shi (KR)

Correspondence Address: LEE & STERBA, P.C., Suite 2000, 1101 Wilson Boulevard, Arlington, VA, 22209, US

(73) Assignee: Samsung Electronics Co., Ltd.

(21) Appl. No.: 10/652,884

(22) Filed: Sep. 2, 2003

Related U.S. Application Data
(63) Continuation-in-part of application No. 10/197,215, filed on Jul. 18, 2002.

(30) Foreign Application Priority Data
Jul. 18, 2001 (KR) 2001-43151
Dec. 13, 2001 (KR) 2001-78965
Aug. 30, 2002 (KR) 2002-51875

(51) Int. Cl. B29D 11/00

(52) U.S. Cl. 264/2.1

(57) ABSTRACT

A method for fabricating a preform for a plastic optical fiber includes filling a reactor with a reactant including a thermal polymerization initiator and a photopolymerization initiator, and simultaneously or alternatively proceeding with a thermal polymerization and a photopolymerization while rotating the reactor, thereby exhibiting improved process properties and physical properties of the preform, compared to when using only one of the initiators.

### RELATED APPLICATION DATA

This application is a continuation-in-part of application Ser. No. 10/197,215, filed Jul. 18, 2002.

### BACKGROUND OF THE INVENTION

1. Field of the Invention

The present invention relates to a method for fabricating a preform for a plastic optical fiber, and more particularly to a method for fabricating a preform for a plastic optical fiber by simultaneously or alternatively proceeding a thermal polymerization and a photopolymerization using a thermal polymerization initiator in combination with a photopolymerization initiator, thereby exhibiting excellent process properties and physical properties of the preform.

2. Description of the Related Art

Optical fibers used in the field of telecommunications are generally classified into single-mode fibers and multi-mode fibers in terms of the transmission mode of optical signal. Optical fibers currently used for long distance and high speed communications are mostly the step-index single-mode optical fibers based on quartz glass. These optical fibers have a diameter as small as 5 microns to 10 microns, and as a result, these glass optical fibers face serious challenges in terms of achieving proper alignment and connection. Accordingly, these glass optical fibers are associated with expensive costs relating to achieving proper alignment and connection.

Alternatively, multi-mode glass optical fibers having a diameter that is larger than the diameter of single-mode optical fibers may be used for short distance communications such as in local area networks (LANs). However, these multi-mode glass optical fibers, in addition to being fragile, also suffer from expensive costs relating to achieving proper alignment and connection and therefore are not widely used. Accordingly, these multi-mode glass optical fibers have been mainly used for short distance communication applications up to 200 meters such as in LANs using a metal cable, for example, a twisted pair or coaxial cable. However, since the data transmission capacity or bandwidth of the metal cable is as low as about 150 Mbps and can not reach transmission speed of 625 Mbps, which is a standard for the year 2000 in accordance with asynchronous transfer mode (ATM), it cannot satisfy the future standard of transmission capacity.

To cope with these problems, the industry has expended great effort and investment over the past 10 years towards development of plastic optical fibers, which can be used in short distance communication applications, such as LANs. Since the diameter of plastic optical fibers can be as large as 0.5 to 1.0 mm which is 100 or more times than that of glass optical fibers, due to its flexibility, its alignment and connection are much easier to achieve than with plastic optical fibers. Moreover, since polymer-based connectors may be produced by compression molding, these connectors can be used both for alignment and for connection and thereby reduce costs.

On the other hand, the plastic optical fiber may have a step-index (SI) structure, in which a refractive index changes stepwise in a radial direction, or a graded-index (GI) structure, in which a refractive index changes gradually in a radial direction. However, since plastic optical fibers having a SI structure have high modal dispersion, the transmission capacity (or bandwidth) of a signal cannot be larger than that of cable. On the other hand, since plastic optical fibers having a GI structure have a low modal dispersion, it can have a large transmission capacity. Therefore, it is known that GI plastic optical fiber is adequate for use as a communication medium for short distance, high-speed communications because of reduced costs derived from its larger diameter and large capacity of data transmission derived from low modal dispersion.

Conventional methods for fabricating GI plastic optical fiber are mainly classified into two methods as follows. The first method is a batch process wherein a preliminary cylindrical molding product, namely, a preform in which a refractive index changes in a radial direction, is fabricated, and then the resultant perform is heated and drawn to fabricate GI plastic optical fiber. The second method is a continuous process wherein a plastic fiber is produced by extrusion process, and then the low molecular material is extracted from the fiber, or contrarily introduced to the fiber to obtain GI plastic optical fiber.

Unlike conventional methods as mentioned above, the present invention uses the principle of centrifugal separation. When a mixture of monomers having different densities and refractive indices or a monomer dissolving a polymer is polymerized under a high level of centrifugal force, a concentration gradient is generated due to the formation of a density gradient, and a refractive index gradient is thereby generated. However, the above method has a limitation in selecting monomers because a monomer in high density should have a higher refractive index that a monomer in low density. Moreover, none of the aforementioned methods mention anything related to the problem inevitably caused by volume shrinkage during (radical) chain polymerization common in the fabrication of GI preform. When volume shrinkage occurs in polymerization of monomer, a preform for a plastic optical fiber fabricated under the rotation of a reactor has a cavity in its center to form a shape of a tube. Thus, it is required to fill the cavity with additional monomer, prepolymer or polymer-dissolving monomers in order to fabricate a cavity-free preform. Accordingly, it is difficult to say that there is an improvement in productivity. Also, there is a possibility of occurring discontinuity of the refractive index profile in the case of cavity-filling type perform. This can lead to a significant or remarkable scattering in the interface, and therefore data transmission capacity is reduced. Accordingly, there is restriction in commercializing this type of optical fiber.

In order to solve the problem of volume shrinkage as mentioned above, the present inventors invented a method for fabricating a preform for a plastic optical fiber using a cavity-preventing reactor, and disclosed it in Korean Patent Appln. No. 2001-78965 and U.S. application. Ser. No. 10/197,215. As claimed in this method, a preform for a plastic optical fiber is fabricated by feeding a mixture of monomers having different refractive indices into the cavity-preventing reactor and polymerizing it with the reactor rotated. Concretely, the cavity-preventing reactor comprises: an introduction part having a reactant inlet through which a reactant is fed into the whole reactor; a reaction part which is adjacent to the introduction part through a blocking wall and has a flow path, through which the reaction part is connected with the introduction part, at the center of the blocking wall; and one or more cavity-preventing structures which exist between the flow path of the reaction part and the reactant inlet of the introduction part, and has one or more flow paths though which the reactant flows from the introduction part to the reaction part, for preventing a cavity developed from the reactant inlet of the introduction part from extending to the reaction part during rotation of the reactor.

In the method, the reactant is thermally polymerized or photopolymerized. The thermal polymerization is a process widely used for the preparation of optical polymers. However, in the case of thermal polymerization, the introduction part of the cavity-preventing reactor may be polymerized due to heat transfer from the reaction part, and so the flow of the reactant can be disturbed. In addition, when only thermal polymerization is applied, reaction time is extended, and so efficiency of the process is lowered.

On the other hand, when photopolymerization is carried out in the cavity-preventing reactor, the polymerization time is short and the flow passages from the introduction part to the reaction part are not occluded. Accordingly, a preform having a uniform refractive index along the longitudinal direction can be fabricated as shown in FIG. 1. However, this photopolymerization causes a problem of high optical loss, as compared to thermal polymerization. In addition, the greater the amount of a photopolymerization initiator used, the higher the optical loss (FIG. 2). Furthermore, since the polymerization is mainly proceeded at the peripheral surface close to a UV light source, cracks are likely to appear, in particular, in a large diameter preform, and mechanical properties of a final optical fiber are deteriorated. Accordingly, the photopolymerization is limited in its application to the preparation of a plastic optical fiber.

### SUMMARY OF THE INVENTION

The present inventors have found that when simultaneously or alternatively proceeding a thermal polymerization and a photopolymerization using a thermal polymerization initiator in combination with a photopolymerization initiator, problems of thermal polymerization and photopolymerization is offset, and further the physical properties of the optical fiber can be improved, and accomplished by the present invention.

In accordance with a feature of a preferred embodiment of the present invention, there is provided a method for fabricating a preform for a plastic optical fiber, the method comprising filling a reactor with a reactant including a thermal polymerization initiator and a photopolymerization initiator, and simultaneously or alternatively proceeding a thermal polymerization and a photopolymerization with the reactor rotated.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a graph showing a uniform refractive index profile along the longitudinal direction of a preform when a photopolymerization initiator is used;

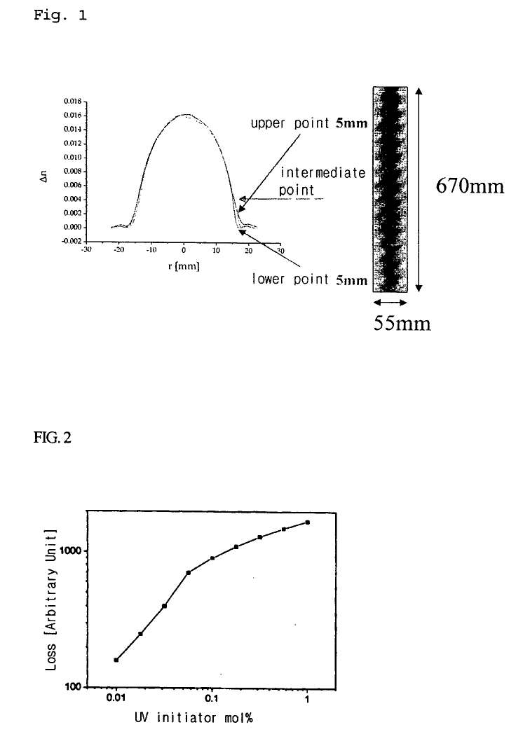

FIG. 2 is a graph showing an optical loss as claimed in an amount of a photopolymerization initiator used;

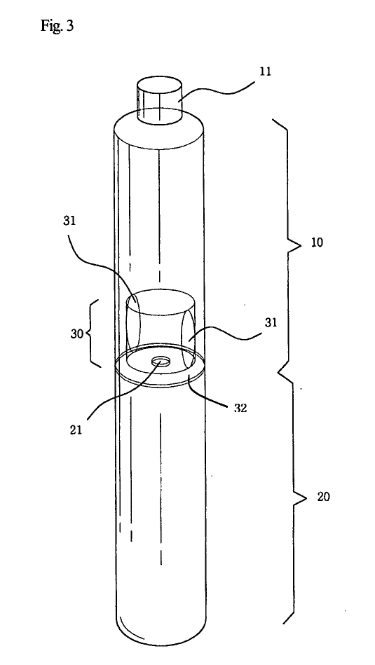

FIG. 3 is a perspective view showing an example of a cavity-preventing reactor usable in the present invention; and

FIGS. 4A to 4C are perspective views showing other reactors usable in the present invention.

### DESCRIPTION OF THE PREFERRED EMBODIMENTS

Korean Patent Application No. 2002-51875, filed on Aug. 30, 2002, and entitled: “Method for Fabricating a Preform for Plastic Optical Fiber,” is incorporated by reference herein in its entirety.

Hereinafter, the present invention will be explained in more detail in the following Examples with reference to the accompanying drawings.

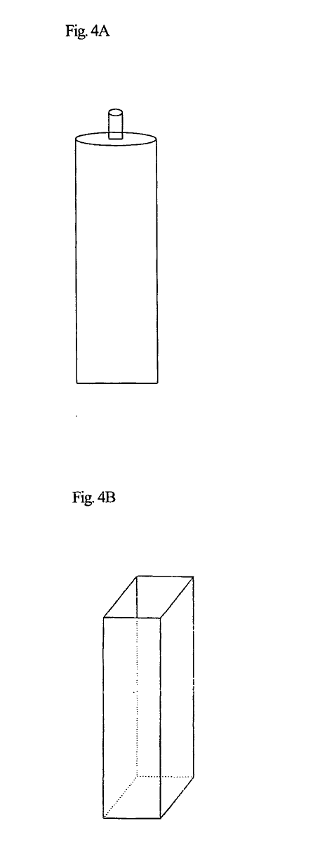

As a reactor usable in the present invention, any of currently used reactors are available. For example, a cavity-preventing reactor disclosed in Korean Patent Appln. No. 2001-78965 and U.S. Pat. application Ser. No. 10/197,215, which was filed by the present inventors, can be used. The cavity-preventing reactor is shown in FIG. 3 and comprises: an introduction part 10 having a reactant inlet 11 through which a reactant is introduced into the whole reactor; a reaction part 20 which is adjacent to the introduction part 10 through a blocking wall 32 and has a flow path 21, through which the reaction part 20 is connected with the introduction part 10, at the center of the blocking wall 32; and one or more cavity-preventing structures 30 which exist between the flow path 21 of the reaction part 20 and the reactant inlet 11 of the introduction part 10, and has one or more flow paths 31 though which the reactant flows from the introduction part 10 to the reaction part 20, for preventing a cavity developed from the reactant inlet 11 of the introduction part 10 from extending to the reaction part 20 during rotation of the reactor.

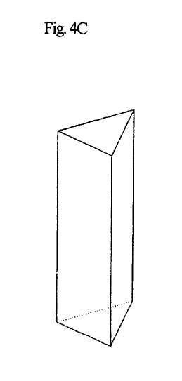

In addition to the reactor as described above, reactors with a circular, a triangular and a quadrangular section, respectively, can be used as depicted in FIGS. 4A to 4C.

As a reactant, a pair of monomers having different indices can be used in the present invention. Alternatively, the reactant can be prepared in accordance with one of the following manners.

i) After a monomer having low refractive index is thermally polymerized and/or photopolymerized to form a prepolymer, the prepolymer is mixed with a monomer having high refractive index.

ii) After two monomers are respectively polymerized to form respective prepolymers, the prepolymers are mixed with each other.

iii) After a monomer having low refractive index is thermally polymerized and/or photopolymerized to form a polymer, the polymer is ground and dissolved in a monomer having high refractive index.

In particular, the mixture of a monomer and a prepolymer is preferred because a density of the monomer having low refractive index can be regulated through prepolymerization and it is possible to select monomers irrespective of their density. In addition, grinding and dissolution processes of a polymer, which occur in the case of dissolving a polymer in a monomer, are avoided.

The term ‘prepolymer’ used herein means a state before a monomer is completely polymerized and solidified. The prepolymer has higher viscosity and density than the monomer prior to polymerizing. The present invention is characterized in that the prepolymer has higher density than the other monomer solution having a relatively high refractive index. The degree of polymerization of the prepolymer is determined by polymerization time and viscosity. The prepolymer used in the present invention has preferably a viscosity of about 50˜500,000 cps (25° C.), and more preferably 500˜10,000 cps (25° C.).

In addition to the monomer, the reactant further includes a thermal polymerization initiator and a photopolymerization initiator for polymerizing the monomer through heating and irradiating, and a chain transfer agent. Unlike the prior arts, the present invention is characterized in that the photopolymerization initiator and the thermal polymerization initiator are used in combination to simultaneously or alternatively proceed photopolymerization and thermal polymerization.

Specific examples of the monomer used in the present invention include, but are not limited to, methylmethacrylate, benzylmethacrylate, phenylmethacrylate, 1-methylcyclohexylmethacrylate, cyclohexylmethacrylate, chlorobenzylmethacrylate, 1-phenylethylmethacrylate, 1,2-diphenylethylmethacrylate, diphenylmethylmethacrylate, furfuryl methacrylate, 1-phenylcyclohexylmethacrylate, pentachlorophenylmethacrylate, pentabromophenylmethacrylate, styrene, TFEMA (2,2,2-trifluoroethylmethacrylate), TFPMA (2,2,3,3-tetrafluoropropylmethacrylate), PFPMA (2,2,3,3,3-pentafluoropropylmethacrylate), HFIPMA (1,1,1,3,3,3-hexafluoroisopropylmethacrylate), HFBM (2,2,3,4,4,4-hexafluorobutylmethacrylate), HFBMA (2,2,3,3,4,4,4-heptafluorobutylmethacrylate) and PFOM (1H,1H-perfluoro-n-octylmethacrylate).

Examples of the thermal polymerization initiator used in the present invention include, but are not limited to, 2,2′-azobis(isobutyronitrile), 1,1′-azobis(cyclohexanecarbonitrile), 2,2′-azobis(2,4-dimethylvaleronitrile), 2,2′-azobis(methylbutyronitrile), di-tert-butyl peroxide, lauroyl peroxide, benzoyl peroxide, tert-butyl peroxide, azo-tert-butane, azo-bis-isopropyl, azo-normal-butane, di-tert-butyl peroxide, etc.

Examples of the photopolymerization initiator used in the present invention include, but are not limited to 4-(para-tolylthio)benzophenone, 4,4′-bis(dimethylamino)benzophenone, 2-methyl4′-(methylthio)-2-morpholino-propiophenone, 1-hydroxy-cyclohexyl-phenyl-ketone, 2-hydroxy-2-methyl-1-phenyl-propan-1-one, benzophenone, 1-(4-[2-hydroxyethoxy)-phenyl]-2-hydroxy-2-methyl-1-propan-1-one, 2-benzyl-2-methylamino-1-(4-morpholinophenyl)-butanone-1,2,2-dimethoxy-1,2-diphenylmethan-1-one, bis(2,4,6-trimethylbenzoyl)-phenylphospinoxide, 2-methyl-1[4-(methylthio)phenyl]-2-morpholinopropan-1-one, bis(.etha.5-2,4-cyclopentadien-1-yl)-bis(2,6-difluoro-3-(1H-pyrro-1-yl)-phenyl) titanium, etc.

Examples of the chain transfer agent used in the present invention include, but are not limited to, normal-butyl-mercaptan, lauryl mercaptan, octyl mercaptan, dodecyl mercaptan, 1-butanethiol, etc.

The amount of the photopolymerization initiator used is determined depending on the initiation rate of the initiator, polymerization rate of the monomer, intensity of and distance from UV light source, glass wall thickness of the reactor, diameter of the reactor, reaction temperature, etc. About 5% by weight or less of the photopolymerization initiator is preferred, and 0.5% by weight or less is more preferred. Since the photopolymerization initiator increases the optical loss of an optical fiber, it is preferred to add in a small amount.

When the thermal polymerization initiator is used together with the photopolymerization initiator, the weight ratio of the thermal polymerization initiator to the photopolymerization initiator is preferably within the range of 0.99: 0.01 to 0.01: 0.99, and more preferably 0.9: 0.1 to 0.1: 0.9. However, a ratio exceeding these ranges is possible considering the reaction conditions for fabricating a preform and types of a preform.

In the method of the present invention, it is preferred to pressurize the interior of the reactor using an inert gas such as argon to prevent the formation of a cavity, and to proceed polymerization in the reactor stably. When the interior of the reactor is pressurized, the boiling point of the monomer is raised and thus polymerization can be proceeded even at high temperature. Accordingly, the polymerization can be completed in a shortened time without formation of bubbles due to unreactants. When the reactor is made of a fragile material, e.g., glass, quartz, ceramic or plastic, it is difficult to raise the internal pressure of the reactor to 4 bars or more. In this case, the exterior of the reactor is pressurized under the same pressure as applied to the interior of the reactor to avoid the breakage of the reactor.

To induce better refractive index distribution in the preform of the present invention, the rotational speed of the reactor can be varied. The variations can be not only a repeated rotation and stopping, but also a velocity function having varying amplitudes and cycles such as a trigonometric function.

In order to allow smooth heat transfer for the polymerization process in the fabrication of the preform for a plastic optical fiber, the preform preferably has a radius of 1˜10 cm. The length of the preform is preferably set to about 100 cm or shorter suitable for a common thermal drawing.

The preform for a plastic optical fiber fabricated in accordance with the method of the present invention is thermally drawn into a refractive index distributed type plastic optical fiber having a desired diameter. Furthermore, the method of the present invention is applicable to producing refractive index distributed type lenses and imaging guides for delivering images.

Hereinafter, the present invention will be described in more detail with reference to the following Examples. However, these Examples are given for the purpose of illustration and are not to be construed as limiting the scope of the invention.

In these Examples, a cavity-preventing reactor, which was similar to that of FIG. 3 was used. The main reaction part of the reactor has a diameter of 50 mm and a height of 400 mm, and an introduction part has a diameter of 70 mm and a height of 200 mm. As a pair of monomers having different refractive indices, benzyl methacrylate (hereinafter, referred to as ‘BMA’) and methyl methacrylate (hereinafter, referred to as ‘MMA’) were used. The density and the refractive index of the BMA are 1.040 and 1.512, respectively, while those of the MMA are 0.936 and 1.414, respectively.

When a prepolymer is prepared, a jacket reactor equipped with a circulator was used in a thermal polymerization initiator, while a transparent reactor equipped with a UV lamp was used in a photopolymerization initiator.

As the thermal polymerization initiator and the photo polymerization initiator, 2,2′-azobisisobutyronitrile (hereinafter, referred to as ‘AIBN’) and 2-hydroxy-2-methyl-1-phenyl-propan-1-one (hereinafter, referred to as ‘HMPP’) were used, respectively. 1-butanethiol (hereinafter, referred to as ‘1-BuSH’) was used as a chain transfer agent.

In the present invention, the optical loss of a plastic optical fiber was determined by drawing a 0.75mm thick optical fiber, cutting the drawn optical fiber at an interval of 1 m, and measuring light intensity outputted from the ends of the cut optical fibers using a 650 nm laser diode.

The yield of the preform was determined by dividing ‘the length of the optical fiber drawn from the preform without formation of any bubbles and defects’ by ‘the maximum length of the optical fiber drawn from the preform’, and specifically was calculated by the following equation (1):

$$Yield of preform ( \% ) = 100 \frac{{l}_{f}}{{l}_{p}} {( \frac{{d}_{f}}{{d}_{p}} )}^{2} \qquad ( 1 )$$

wherein lₚ is a length of the preform, l_{f} is a length of the optical fiber drawn from the preform, dₚ is a diameter of the preform, and d_{f} is a diameter of the drawn optical fiber.

The yield of preform was calculated by averaging measured values from 5 preforms fabricated in the same manner.

### Example 1

AIBN and 1-BuSH were added to 510 g of MMA in the concentration of 0.066% and 0.2% by weight, respectively. The mixture thus prepared was charged into a jacket reactor, and polymerized at the temperature of 75° C. for 1 hour with rapid stirring to obtain a prepolymer. The prepolymer thus obtained was charged into a main reaction part of a cavity-preventing reactor, and then polymerized at the temperature of 75° C. for 12 hours with the reactor rotated at the speed of 3,000 rpm to form a clad. Next, AIBN, HMPP and 1-BuSH were added to 338 g of MMA in the concentration of 0.066%, 0.022% and 0.3% by weight, respectively. The mixture thus prepared was charged into a jacket reactor, and polymerized at the temperature of 75° C. for 40 minutes to prepare a prepolymer. To the prepolymer, 120 g of BMA was added and then stirred for 2 minutes. The resulting mixture was charged into the cavity-preventing reactor, in which the clad had previously formed, to fill the reactor, and polymerized at the temperature of 75° C. for 12 hours with the reactor rotated at a speed of 3,000 rpm and irradiated with UV light to fabricate a preform for a plastic optical fiber in a yield of 93%. The optical loss of 0.75 mm thick plastic optical fiber drawn from the preform was measured to be 195 dB/km.

### Example 2

AIBN and 1-BuSH were added to 510 g of MMA in the concentration of 0.066% and 0.2% by weight, respectively. The mixture thus prepared was charged into a main reaction part of a cavity-preventing reactor, and polymerized at the temperature of 75° C. for 24 hours with the reactor rotated at the speed of 3,000rpm to form a clad. Next, AIBN and 1-BuSH were added to 338g of MMA in the concentration of 0.066% and 0.2% by weight, respectively. The mixture thus prepared was charged into a jacket reactor, and heated to 75° C. for 40 minutes to prepare a prepolymer. To the prepolymer, 120 g of BMA containing 0.022% by weight of HMPP and 0.2% by weight of 1-BuSH was added and then stirred for 2 minutes. The resulting mixture was charged into the cavity-preventing reactor, in which the clad had previously formed, to fill the reactor, and polymerized at the temperature of 75° C. for 12 hours with the reactor rotated at the speed of 3,000 rpm and irradiated with UV light to fabricate a preform for a plastic optical fiber in a yield of 95%. The optical loss of 0.75 mm thick plastic optical fiber drawn from the preform was measured to be 190 dB/km.

### Comparative Example 1

HMPP and 1-BuSH were added to 510 g of MMA in the concentration of 0.066 and 0.2% by weight, respectively. The mixture thus prepared was charged into a main reaction part of a cavity-preventing reactor, and polymerized at the temperature of 60° C. for 12 hours with the reactor rotated at the speed of 3,000 rpm and irradiated with UV light to form a clad. Next, HMPP and 1-BuSH were added to 338 g of MMA in the concentration of 0.066% and 0.2% by weight, respectively. The mixture thus prepared was polymerized at the temperature of 60° C. for 40 minutes with the reactor irradiated with UV light, to prepare a prepolymer. To the prepolymer, 120 g of BMA containing 0.066% by weight of HMPP and 0.2% by weight of 1-BuSH was added and then stirred for 2 minutes. The resulting mixture was charged into the cavity-preventing reactor, in which the clad had previously formed, to fill the reactor, and polymerized at the temperature of 60° C. for 12 hours with the reactor rotated at the speed of 3,000 rpm and irradiated with UV light to fabricate a preform for a plastic optical fiber in a yield of 98%. The optical loss of 0.75mm thick plastic optical fiber drawn from the preform was measured to be 310 dB/km.

### Comparative Example 2

AIBN and 1-BuSH were added to 510 g of MMA in the concentration of 0.066% and 0.2% by weight, respectively. The mixture thus prepared was charged into a main reaction part of a cavity-preventing reactor, and polymerized at the temperature of 75° C. for 24 hours with the reactor rotated at the speed of 3,000 rpm to form a clad. Next, AIBN and 1-BuSH were added to 338 g of MMA in the concentration of 0.066% and 0.2% by weight, respectively. The mixture thus prepared was charged into a jacket reactor, and polymerized at the temperature of 75° C. for 40 minutes to prepare a prepolymer. To the prepolymer, 120 g of BMA containing 0.066% by weight of AIBN and 0.2% by weight of 1-BuSH was added and then stirred for 2 minutes. The resulting mixture was charged into the cavity-preventing reactor, in which the clad had previously formed, to fill the reactor, and polymerized at the temperature of 75° C. for 36 hours with the reactor rotated at the speed of 3,000 rpm to fabricate a preform for a plastic optical fiber in a yield of 68%. The optical loss of 0.75mm thick plastic optical fiber drawn from the preform was measured to be 180dB/km.

### Comparative Example 3

HMPP and 1-BuSH were added to 510 g of MMA in the concentration of 0.066 and 0.2% by weight, respectively. The mixture thus prepared was charged into a main reaction part of a cavity-preventing reactor, and polymerized at the temperature of 30° C. for 12 hours with the reactor rotated at the speed of 3,000 rpm and irradiated with UV light to form a clad. Next, HMPP and 1-BuSH were added to 338 g of MMA in the concentration of 0.066% and 0.2% by weight, respectively. The mixture thus prepared was polymerized at the temperature of 30° C. for 40 minutes to prepare a prepolymer with UV light irradiation. To the prepolymer, 120 g of BMA containing 0.066% by weight of HMPP and 0.2% by weight of 1-BuSH was added and then stirred for 2 minutes. The resulting mixture was charged into the cavity-preventing reactor in which the clad had previously formed, and polymerized at the temperature of 30° C. for 12 hours with the reactor rotated at the speed of 3,000 rpm and irradiated with UV light to fabricate a preform for a plastic optical fiber. Cracks occurred in one of 5 preforms fabricated in the same manner. The yield of the preform was 82%. The optical loss of 0.75 mm thick plastic optical fiber drawn from the preform was measured to be 380 dB/km.

### Example 3

AIBN and 1-BuSH were added to 510 g of MMA in the concentration of 0.066% and 0.2% by weight in MMA, respectively. The mixture thus prepared was charged into a main reaction part of a cavity-preventing reactor, and polymerized at the temperature of 75° C. for 24 hours with the reactor rotated at the speed of 3,000 rpm to form a clad. Next, AIBN and 1-BuSH were added to 338 g of MMA in the concentration of 0.066% and 0.2% by weight, respectively. The mixture thus prepared was charged into a jacket reactor, and polymerized at the temperature of 75° C. for 40 minutes to prepare a prepolymer. Separately, 120 g of BMA containing 0.022% by weight of HMPP and 0.2% by weight of 1-BuSH was irradiated with UV light to prepare another prepolymer. The two prepolymers were mixed and stirred for 5 minutes. The resulting mixture was charged into the cavity-preventing reactor, in which the clad had previously formed, to fill the reactor, and polymerized at the temperature of 75° C. for 12 hours with the reactor rotated at the speed of 3,000 rpm and irradiated with UV light to fabricate a preform for a plastic optical fiber in a yield of 96%. The optical loss of 0.75 mm thick plastic optical fiber drawn from the preform was measured to be 205 dB/km.

### Example 4

AIBN and 1-BuSH were added to 1,000 g of MMA in the concentration of 0.066% and 0.2% by weight, respectively. The mixture thus prepared was charged into a jacket reactor, and polymerized at the temperature of 75° C. for 2.5 hours with rapid stirring to prepare a prepolymer. The prepolymer thus prepared was cooled to 25° C. and stored under nitrogen atmosphere containing no moisture. At this time, a small amount of the MMA monomer was added to the prepolymer so that the prepolymer had a viscosity of 1,000 cps. 500 g of the viscosity-controlled prepolymer was charged into a main reaction part of a cavity-preventing reactor and then polymerized at the temperature of 75° C. for 12 hours with the reactor rotated at the speed of 1,000 rpm to form a clad, and then the temperature was lowered to 45° C. Next, 120 g of BMA containing 0.066% by weight of HMPP and 0.2% by weight of 1-BuSH was added to 320 g of the prepolymer, and then stirred for 2 minutes. The resulting mixture was charged into the cavity-preventing reactor, in which the clad had previously formed, to fill the reactor, and polymerized at the temperature of 45° C. for 12 hours with the reactor rotated at the speed of 3,000 rpm and irradiated with UV light to fabricate a preform for a plastic optical fiber in a yield of 98%. The optical loss of 0.75mm thick plastic optical fiber drawn from the preform was measured to be 193 dB/km.

In these Examples, the preforms fabricated by copolymerization of BMA and MMA were an amorphous random copolymer.

Preferred embodiments of the present invention have been disclosed herein and, although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A method for fabricating a preform for a plastic optical fiber, comprising filling a reactor with a reactant including a thermal polymerization initiator and a photopolymerization initiator, and simultaneously or alternatively proceeding with a thermal polymerization and a photopolymerization while rotating the reactor.

2. The method for fabricating a preform for a plastic optical fiber as claimed in claim 1, wherein the reactor is a cavity-preventing reactor comprising an introduction part having a reactant inlet through which a reactant is fed into the whole reactor; a reaction part which is adjacent to the introduction part through a blocking wall and has a flow path, through which the reaction part is connected with the introduction part, at the center of the blocking wall; and one or more cavity-preventing structures which exist between the flow path of the reaction part and the reactant inlet of the introduction part, and has one or more flow paths though which the reactant flows from the introduction part to the reaction part, for preventing a cavity developed from the reactant inlet of the introduction part from extending to the reaction part during rotation of the reactor.

3. The method for fabricating a preform for a plastic optical fiber as claimed in claim 1, wherein the reactant comprises a mixture selected form the group consisting of a mixture of a pair of monomers having different refractive indices, a mixture of a prepolymer polymerized form a monomer having a low refractive index and a monomer having a high refractive index, a mixture of a prepolymer polymerized form a monomer having a low refractive index and a prepolymer polymerized a monomer having a high refractive index, and a mixture prepared by dissolving a polymer having a low refractive index in a monomer having a high refractive index; a thermal polymerization initiator, a photopolymerization initiator; and a chain transfer agent.

4. The method for fabricating a perform for a plastic optical fiber as claimed in claim 3, wherein the monomer is selected from the group consisting of methylmethacrylate, benzylmethacrylate, phenylmethacrylate, 1-methylcyclohexylmethacrylate, cyclohexylmethacrylate, chlorobenzylmethacrylate, 1-phenylethylmethacrylate, 1,2-diphenylethylmethacrylate, diphenylmethylmethacrylate, furfuryl methacrylate, 1-phenylcyclohexylmethacrylate, pentachlorophenylmethacrylate, pentabromophenylmethacrylate, styrene, TFEMA (2,2,2-trifluoroethylmethacrylate), TFPMA (2,2,3,3-tetrafluoropropylmethacrylate), PFPMA (2,2,3,3,3-pentafluoropropylmethacrylate), HFIPMA (1,1,1,3,3,3-hexafluoroisopropylmethacrylate), HFBM (2,2,3,4,4,4-hexafluorobutylmethacrylate), HFBMA (2,2,3,3,4,4,4-heptafluorobutylmethacrylate) and PFOM (1H,1H-perfluoro-n-octylmethacrylate).

5. The method for fabricating a perform for a plastic optical fiber as claimed in claim 3, wherein the thermal polymerization initiator is selected from the group consisting of 2,2′-azobis(isobutyronitrile), 1,1′-azobis(cyclohexanecarbonitrile), 2,2′-azobis(2,4-dimethylvaleronitrile), 2,2′-azobis(methylbutyronitrile), di-tert-butyl peroxide, lauroyl peroxide, benzoyl peroxide, tert-butyl peroxide, azo-tert-butane, azo-bis-isopropyl, azo-normal-butane and di-tert-butyl peroxide.

6. The method for fabricating a perform for a plastic optical fiber as claimed in claim 3, wherein the photopolymerization initiator is selected from the group consisting of 4-(para-tolylthio)benzophenone, 4,4′-bis(dimethylamino)benzophenone, 2-methyl-4′-(methylthio)-2-morpholino-propiophenone, 1-hydroxy-cyclohexyl-phenyl-ketone, 2-hydroxy-2-methyl-1-phenyl-propan-1-one, benzophenone, 1-[4-(2-hydroxyethoxy-phenyl]-2-hydroxy-2-methyl-1-propan-1-one, 2-benzyl-2-methylamino-1-(4-morpholinophenyl)-butanone-1,2,2-dimethoxy-1,2-diphenylmethan-1-one, bis(2,4,6-trimethylbenzoyl)-phenylphospinoxide, 2-methyl-1[4-(methylthio)phenyl]-2-morpholinopropan-1-one and bis(.etha.5-2,4-cyclopentadien-1-yl)-bis(2,6-difluoro-3-(1H-pyrro-1-yl)-phenyl) titanium.

7. The method for fabricating a perform for a plastic optical fiber as claimed in claim 3, wherein the chain transfer agent is selected from the group consisting of normal-butyl-mercaptan, lauryl mercaptan, octyl mercaptan, dodecyl mercaptan, and 1-butanethiol.

8. The method for fabricating a preform for a plastic optical fiber as claimed in claim 3, wherein the prepolymer has a viscosity of 50˜500,000 cps (25° C.).

9. The method for fabricating a preform for a plastic optical fiber as claimed in claim 3, wherein the weight ratio of the thermal polymerization initiator to the photopolymerization initiator is within the range of 0.99:0.01 to 0.01:0.99.

10. The method for fabricating a preform for a plastic optical fiber as claimed in claim 1, wherein the reactor is rotated in a constant or varied rotational speed.

11. The method for fabricating a preform for a plastic optical fiber as claimed in claim 1, wherein the variable rotation of the reactor is carried out by a repeated high-speed and low-speed rotation or stopping, or a rotational velocity function having varying cycles, phases and amplitudes such as a trigonometric function.

12. The method for fabricating a preform for a plastic optical fiber as claimed in claim 2, wherein the reactant is polymerized while the interior of the reactor is pressurized using an inert gas.
